(19) United States
(12) Patent Application Publication
(10) Pub. No.: US 2016/0104931 A1
(43) Pub. Date: Apr. 14, 2016

(54) VEHICLE LOOP ANTENNA

(71) Applicants: Hyundai Motor Company, Seoul (KR); Kia Motors Corporation, Seoul (KR)

(72) Inventor: Jin Han Chang, Ansan (KR)

(21) Appl. No.: 14/870,887

(22) Filed: Sep. 30, 2015

(30) Foreign Application Priority Data
Oct. 8, 2014 (KR) 10-2014-0136039

(51) Int. Cl. H01Q 1/27; H01Q 1/48; H01Q 7/00

(52) U.S. Cl. CPC H01Q 1/27; H01Q 7/00; H01Q 1/48

(57) ABSTRACT

A vehicle loop antenna is provided and includes a watertight plate attached to a loop panel and having a plurality of watertight ribs formed on an upper surface thereof. The plurality of watertight ribs particularly limit the introduction of a liquid. Additionally, a base is disposed on the upper surface of the water-tight plate and has a screw part formed on a lower surface thereof. The screw part penetrates through the watertight plate and protrudes to an inner portion of the loop panel. A case is attached to an upper surface of the base and a ground nut is fastened to the screw part to fix the watertight plate and the base to the loop panel. The ground nut includes a plurality of sawteeth formed at an upper end thereof contact the loop panel. The vehicle loop antenna prevents a liquid from being introduced into an interior of a vehicle.

### CROSS-REFERENCE TO RELATED APPLICATION

This application is based on and claims the benefit of priority to Korean Patent Application No. 10-20140136039, filed on Oct. 8, 2014 in the Korean Intellectual Property Office, the disclosure of which is incorporated herein in its entirety by reference.

### TECHNICAL FIELD

The present disclosure relates to a vehicle loop antenna, and more particularly, to a vehicle loop antenna that prevents a liquid from being introduced into an interior of a vehicle.

### BACKGROUND

Generally, a vehicle is mounted with apparatuses such as a radio, a navigation system, and the like. The radio includes an antenna used to receive a frequency. Conventionally, a multi-stage folding antenna has been mounted within the vehicle. In accordance with a design change and structural development of the antenna, an antenna mounted on a loop panel has been developed.

However, in a vehicle loop antenna mounted on a loop of the vehicle, a lower surface of the antenna is not completely adhered to the loop panel due to a curvature of the loop panel, thus causing an increase in a risk of an air gap generation, and the possibility of water leakage through the air gap.

### SUMMARY

The present disclosure provides a vehicle loop antenna capable of preventing a liquid from being introduced into an interior of a vehicle.

According to an exemplary embodiment of the present disclosure a vehicle loop antenna may include a watertight plate attached to a loop panel and having a plurality of watertight ribs formed on an upper surface thereof, the plurality of watertight ribs limiting introduction of a liquid; a base positioned on the upper surface of the water-tight plate and having a screw part formed on a lower surface thereof, the screw part penetrating through the watertight plate and then protruding to an inner portion of the loop panel; a case attached to an upper surface of the base; and a ground nut fastened to the screw part to fix the watertight plate and the base to the loop panel and having a plurality of sawteeth formed at an upper end thereof contacting the loop panel, the sawteeth having a right triangular shape.

According to another exemplary embodiment of the present disclosure, a ground nut of a vehicle loop antenna may include a nut part fastened to a screw part protruding from the vehicle loop antenna attached to the loop panel to an inner portion of the loop panel and a ground part formed at an upper end of the nut part and grounding the screw part and the loop panel.

### BRIEF DESCRIPTION OF THE DRAWINGS

The above and other objects, features and advantages of the present disclosure will be more apparent from the following detailed description taken in conjunction with the accompanying drawings.

FIG. 1 is a cross-sectional view of a vehicle loop antenna according to an exemplary embodiment of the present disclosure;

FIG. 2 is a view of a ground nut included in the vehicle loop antenna of FIG. 1 according to an exemplary embodiment of the present disclosure;

FIG. 3 is a plan view of a watertight plate included in the vehicle loop antenna of FIG. 1 according to an exemplary embodiment of the present disclosure; and

FIG. 4 is a view and a mounting illustrative view of the vehicle loop antenna of FIG. 1 according to an exemplary embodiment of the present disclosure.

### DETAILED DESCRIPTION

Exemplary embodiments of the present disclosure will be described in detail with reference to the accompanying drawings.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, combustion, plug-in hybrid electric vehicles, hydrogen-powered vehicles and other alternative fuel vehicles (e.g. fuels derived from resources other than petroleum).

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

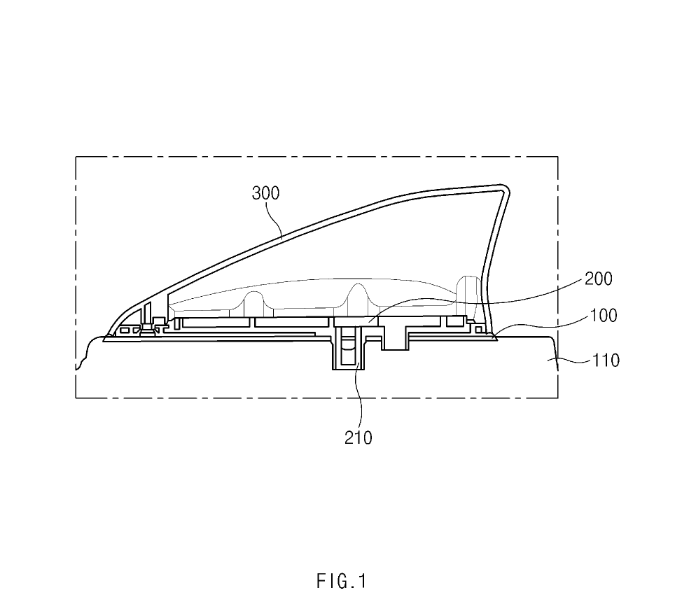

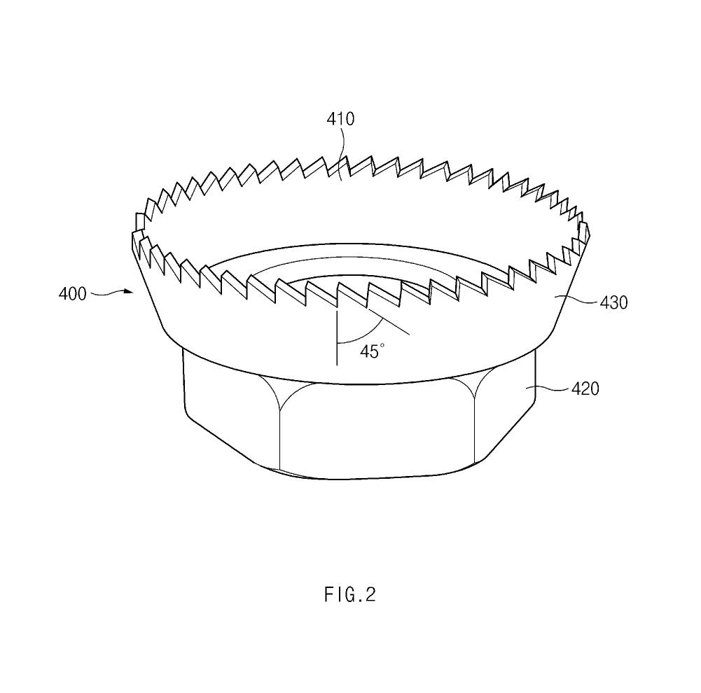

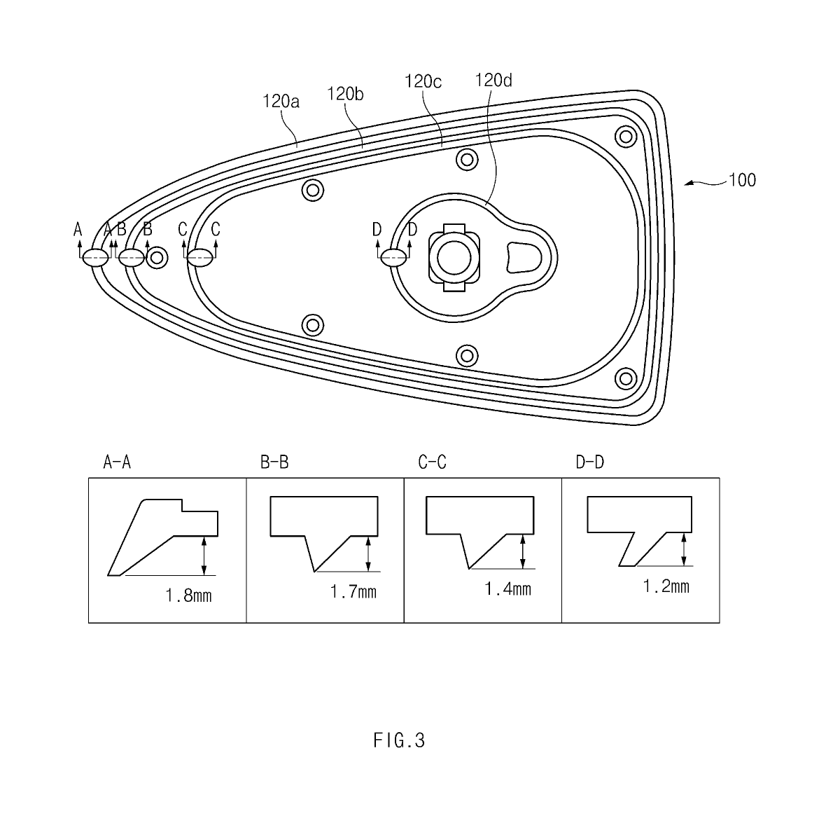

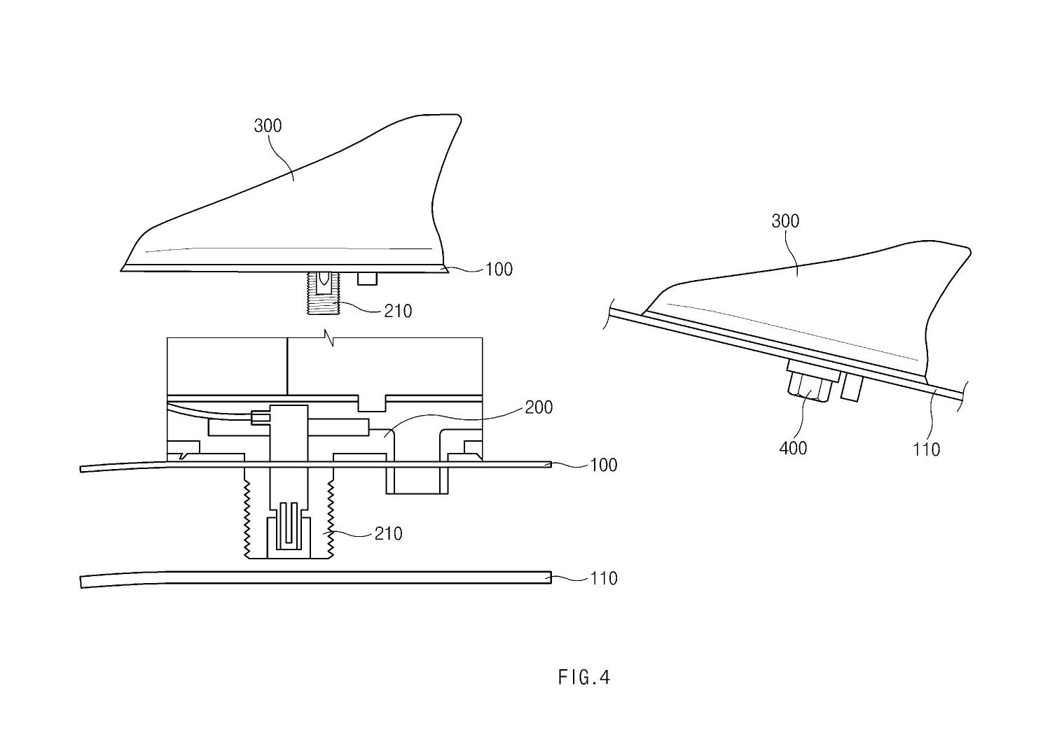

FIG. 1 is a cross-sectional view of a vehicle loop antenna according to an exemplary embodiment of the present disclosure, FIG. 2 is a view of a ground nut included in the vehicle loop antenna of FIG. 1, FIG. 3 is a plan view of a watertight plate included in the vehicle loop antenna of FIG. 1, and FIG. 4 is a view and a mounting illustrative view of the vehicle loop antenna of FIG. 1.

As illustrated in FIGS. 1 to 4, the vehicle loop antenna according to an exemplary embodiment of the present disclosure may include a watertight plate 100 attached to a loop panel 110 and having a plurality of watertight ribs 120 formed on an upper surface thereof, wherein the plurality of watertight ribs 120 are configured to limit the introduction of a liquid; a base 200 positioned on the upper surface of the water-tight plate 100 and having a screw part 210 formed on a lower surface thereof, the screw part 210 penetrating through the watertight plate 100 and then protruding to an inner portion of the loop panel 110; a case 300 attached to an upper surface of the base 200; and a ground nut 400 fastened to the screw part 210 to fix the watertight plate 100 and the base 200 to the loop panel 110 and having a plurality of sawteeth 410 formed at an upper end thereof contacting the loop panel 110, the sawteeth 410 having a substantially right triangular shape.

The watertight plate 100 may include a plurality of rubber pads disposed along an outer peripheral thereof. The rubber pads may be disposed on both of lower and upper surfaces of the watertight plate 100, and may close or seal an air gap generated between the watertight plate 100 and the loop panel 110 and an air gap that may be generated between the watertight plate 100 and the case 300, thereby preventing a liquid from being introduced (e.g., entering) into the vehicle loop antenna according to an exemplary embodiment of the present disclosure.

In an exemplary embodiment of the present disclosure, multiple watertight ribs (e.g., four watertight ribs, 120a to 120d) may be formed on the lower and upper surfaces of the watertight plate 100, respectively, as illustrated in FIG. 3, and cross-sectional shapes and heights of the respective watertight ribs 120 may be different from each other. In particular, cross sections of the watertight ribs 120a to 120d may have a gradient (e.g., a slope) from an inner side of the watertight plate 100 toward an outer side of the watertight plate 100 to prevent a liquid from being introduced from the exterior to the inside. Further, the first watertight rib 120a may have a height of about 1.8 mm or greater, the second watertight rib 120b may have a height of about 1.7 mm or greater, the third watertight rib 120c may have a height of about 1.4 mm or greater, and the fourth watertight rib 120d may have a height of about 1.2 mm or greater. Additionally, a seating groove part in which the watertight plate 100 is seated may be formed in the loop panel 110.

Furthermore, the case 300 may include a space part formed therein to allow an antenna mounted on the base 200 to be accommodated therein. A wire may be connected to the antenna mounted on the base 200 and may extend into the loop panel 110 through the screw part 210 disposed in the base 200. The ground nut 400 may be configured to generate fastening force to maintain the attachment between the vehicle loop antenna to the loop panel. In addition, the ground nut 400 may contact (e.g., abut) the loop panel to ground the antenna to the loop panel 110. The ground nut 400 may include a nut part 420 fastened to the screw part 210 that protrudes from the vehicle loop antenna attached to the loop panel 100 to the inner portion of the loop panel 110 and a ground part formed at an upper end of the nut part 420 and that grounds the screw part 210 and the loop panel 110. The ground part 430 may include the plurality of sawteeth 410 that protrude from the nut part 420 toward the loop panel 110.

Particularly, each sawtooth 410 may have a substantially right triangular shape in which one side thereof is perpendicular to the loop panel 110, as described above. Since one side of the sawtooth 410 is perpendicular to the loop panel 110, when reverse rotation is applied to the ground nut 400 by external force, an end portion of one side of the sawtooth 410 may be damaged, thus increasing frictional force, or a groove may be formed in the loop panel 110 by the end portion of one side of the sawtooth 410, thus increasing frictional force.

Additionally, the sawtooth 410 may be formed with an angle of about 30 to 60 degrees formed by an oblique side of the sawtooth 410 and the loop panel 110. In an exemplary embodiment of the present disclosure, the sawtooth 410 maybe formed with an angle of about 45 degrees formed by the oblique side of the sawtooth 410 and the loop panel 110.

When one side of the sawtooth 410 and the loop panel 110 are not perpendicular to each other, and both surfaces of the sawtooth 410 may form a predetermined angle, for example, about 85 degrees, with respect to the loop panel 110, and thus, an unfastening phenomenon may occur between the nut part 420 and the screw part 210 (e.g., the fastening therebetween becomes loose occurs) due to vibrations generated as the vehicle is driven for a substantial period of time. Due to the unfastening phenomenon, fastening force for maintaining adhesion between the vehicle loop antenna and the loop panel 110 may decrease, thus increasing the risk of an air gap generation.

However, each sawtooth 410 may be formed with one surface thereof perpendicular to the loop panel 110 and the oblique side thereof may form an angle of about 45 degrees with respect to the loop panel 110. Additionally, friction between the sawtooth 410 and the loop panel 110 may be increased thus preventing the unfastening phenomenon. Therefore, the oblique side of the sawtooth 410 may form an angle of about 45 degrees with respect to the loop panel 110, to thus prevent the unfastening phenomenon from occurring and the generation of the air gap, thereby preventing leakage of water.

As described above, in the vehicle loop antenna according to an exemplary embodiment of the present disclosure, the sawteeth perpendicular to the loop panel and having the right triangular shape may be formed in the ground nut maintaining adhesion between the loop panel and the antenna, such that reverse rotation of the ground nut by external force may be prevented, fastening force between the vehicle loop antenna and the loop panel by the ground nut may be improved, and introduction of a liquid into the interior of the vehicle may be prevented.

Hereinabove, although the present disclosure has been described with reference to exemplary embodiments and the accompanying drawings, the present disclosure is not limited thereto, but may be variously modified and altered by those skilled in the art to which the present disclosure pertains without departing from the spirit and scope of the present disclosure claimed in the following claims.

What is claimed is:

1. A vehicle loop antenna, comprising:
a watertight plate attached to a loop panel and having a plurality of watertight ribs formed on an upper surface of the watertight plate, wherein the plurality of watertight ribs are configured to limit introduction of a liquid;
a base disposed on the upper surface of the watertight plate and having a screw part formed on a lower surface of the watertight plate, wherein the screw part penetrates through the watertight plate and protrudes to an inner portion of the loop panel;
a case attached to an upper surface of the base; and
a ground nut fastened to the screw part to fix the watertight plate and the base to the loop panel and having a plurality of sawteeth formed at an upper end thereof contacting the loop panel, wherein the sawteeth have a right triangular shape.

2. The vehicle loop antenna according to claim 1, wherein one side of each sawtooth forms an angle of about 30 to 60 degrees with respect to the loop panel.

3. The vehicle loop antenna according to claim 1, wherein one side of each sawtooth forms an angle of about 45 degrees with respect to the loop panel.

4. The vehicle loop antenna according to claim 1, wherein the watertight plate includes rubber pads disposed along an outer peripheral of the watertight plate.

5. The vehicle loop antenna according to claim 1, wherein the case includes a space part formed therein to accommodate therein an antenna mounted on the base.

6. A ground nut of a vehicle loop antenna, comprising:
a nut part fastened to a screw part that protrudes from the vehicle loop antenna attached to the loop panel to an inner portion of the loop panel; and
a ground part formed at an upper end of the nut part and that grounds the screw part and the loop panel.

7. The ground nut of a vehicle loop antenna according to claim 6, wherein the ground part includes a plurality of sawteeth that protrude from the nut part toward the loop panel.

8. The ground nut of a vehicle loop antenna according to claim 7, wherein each sawtooth has a right triangular shape.

9. The ground nut of a vehicle loop antenna according to claim 8, wherein one side of each sawtooth forms an angle of about 30 to 60 degrees with respect to the loop panel.

10. The ground nut of a vehicle loop antenna according to claim 8, wherein one side of each sawtooth forms an angle of about 45 degrees with respect to the loop panel.

11. The vehicle loop antenna according to claim 1, wherein the ground nut includes four sawteeth.

12. The vehicle loop antenna according to claim 11, wherein a first watertight rib has a height of about 1.8 mm or greater, a second watertight rib has a height of about 1.7 mm or greater, a third watertight rib has a height of about 1.4 mm or greater, and a fourth watertight rib has a height of about 1.2 mm or greater.

13. The vehicle loop antenna according to claim 12, further comprising:
a seating groove part in which the watertight plate, formed in the loop panel.
